(19) United States
(12) Patent Application Publication
(10) Pub. No.: US 2017/0255984 A1
(43) Pub. Date: Sep. 7, 2017

(54) GENERATING PROPOSED MODEL LIST FOR PROPOSED STATE ANALYSIS

(71) Applicant: Kenji HAGIWARA, Edgewater, NJ (US)

(72) Inventor: Kenji HAGIWARA, Edgewater, NJ (US)

(73) Assignee: RICOH COMPANY, LTD., Tokyo (JP)

(21) Appl. No.: 15/058,370

(22) Filed: Mar. 2, 2016

(51) Int. Cl. G06Q 30/06; G06F 3/0484; G06Q 10/06; G06F 3/0482

(52) U.S. Cl. CPC G06Q 30/0631; G06F 3/0482; G06F 3/04847; G06Q 10/06315; G06Q 30/0641

(57) ABSTRACT

Systems, apparatuses, applications and methodologies are configured for a user to generate, based on a proposed model list, a proposed state analysis of a proposed fleet of devices, for a customer. By limiting the devices that can be added to the proposed fleet to those encompassed by the proposed model list, the objective of arriving at a proposal for the customer becomes a manageable task.

### TECHNICAL FIELD

This disclosure relates to tools (for example, systems, apparatuses, applications, methodologies, etc.) for performing a proposed state analysis of a fleet of devices, for an enterprise or another organization.

### BACKGROUND

In the current information age, information technology (IT) tools are extensively used in enterprises and other organizations in order to facilitate communication and processing of information, documents, data, etc. Indeed, it is now rare to find a workflow in an enterprise that does not employ IT tools. The number of IT assets [such as software, computers, printers, scanners, multi-function devices (MFDs), other network-connected or standalone devices] is generally increasing and, as a result, managing IT assets to meet enterprise needs is becoming a daunting task.

One approach for a vendor to make an educated and intriguing sales pitch to a customer or prospective customer is to present a proposal along with an analysis of the current IT expenditures of the customer or prospective customer. For example, a customer may wish to know, and a current state analysis may be prepared to show, total cost of ownership, or expected expenditures (such as for consumables) for devices [e.g., printers, scanners, facsimile devices, multi-function peripherals (MFP), etc.] for each period of one or more months, a year, 3 years, etc., output volumes, etc. Accordingly, the vendor typically attempts to determine the current IT assets of the customer or prospective customer and then collate information such as, but not limited to, acquisition type (i.e. lease/purchase), acquisition cost, depreciation of product, service cost, and in the case of printing products/services, consumables (e.g., paper, ink, toner, etc.) usage or cost, output, etc. Further, the vendor may analyze the needs of the customer or prospective customer in order to be able to offer a package of products and/or services that is attractive to the customer or prospective customer.

However, since a virtually infinite number of device models are typically available in the market for consideration, there exists a need for an improved approach for presenting a manageable number of device models for consideration.

### SUMMARY

Various tools (e.g., systems, apparatuses, methodologies, computer program products, application software, etc.) can be configured to include any combination of various aspects and features described herein, to perform a proposed state analysis of a proposed fleet of devices. Such tools can be employed by sales or marketing personnel, as well as by a customer, in a case of new sale, as well as in the instance of contract renewal, to obtain a proposed state analysis of a proposed fleet of devices for the customer. The proposed state analysis may be based on, and compared to, a current state analysis of the current fleet of devices employed by the customer or a customer site, so that the customer can more readily understand the difference between proposed state and current state.

While a virtually infinite number of device models can be available in the market, there are many practical reasons why it would not be desirable to consider each and every model. For example, there may already be a contract defining the models that the customer would consider. As another example, some models may (or may be considered by the customer to) be out-dated. In another example, some models may not be advantageous for the customer, or it may not be advantageous to the vendor to market such model to the customer. Accordingly, the tools are configured to maintain a list (or database) of proposed device models, suitable for the customer, and only devices encompassed by such list may be added to the proposed state for the customer.

In an aspect of this disclosure, a device marketing application is configured to generate a proposed state analysis of a proposed fleet of devices for a customer, and such device marketing application includes a registration user interface to receive user selection of a device model from a system database, and a registration module registers the selected device model amongst proposed device models maintained by the registration module. Further, a selection user interface displays a proposed model list including the proposed device models registered by the registration module, and receive user selection of a proposed model from the displayed list of proposed device models. A selection module adds a specified device of the selected model to the proposed fleet of devices for the proposed state analysis.

The process of compiling the proposed model list can include various aspects or steps. For example, the proposed model list can be supplemented by a current model list of device models amongst a current fleet of devices employed by the customer. The selection user interface (or the registration user interface) can be configured to additionally display the current model list and permits the user to select a device model from the current model list and add the selected model to the proposed fleet of devices for the proposed state analysis.

In another aspect, the selection user interface can be configured to operate in any of (ii) a current models only mode in which the selection user interface permits the user to add only a device of a model selected from the current model list to the proposed fleet of devices, (ii) a proposed models only mode in which the selection user interface permits the user to add only a device of a model selected from the proposed model list, and (iii) a proposed models and current models mode in which the selection user interface permits the user to add a device of a model selected from the current model list or the proposed model list. For example, in the current models only mode, the selection user interface displays only the current model list and does not display the proposed model list; in the proposed models only mode, the selection user interface displays only the proposed model list and does not display the current model list; and in the proposed models and current models mode, the selection user interface displays both of the current model list and the proposed model list. In another example, in the current models only mode, the proposed state analysis is generated based on only devices of models in the current model list, and in the proposed models only mode, the proposed state analysis is generated based on only devices of models in the proposed model list.

In another aspect, the selection module (or the registration module) can be configured to automatically populate the proposed model list with available models identified in a contract database.

In another aspect, the registration module automatically registers, to the proposed model list maintained by the registration module, device models amongst a current fleet of devices employed by the customer, and the registration module permits the user to unregister a current model from the proposed model list.

In another aspect, the proposed model list may be made available for generating multiple proposed state analyses and multiple proposed fleets of devices, for the customer.

In another aspect, the same proposed model list may be made available for generating proposed state analyses and proposed fleets of devices, for multiple customers.

In another aspect, the same proposed model list may be made available for generating multiple proposed state analyses based on respective proposed fleets of devices, for multiple sites of the customer.

In another aspect, the proposed model list may be made available to each of multiple users.

In another embodiment, the aforementioned tools may be configured to perform a method that includes: providing a registration user interface to receive user selection of a device model from a system database; registering the selected device model amongst proposed device models; providing a selection user interface to display a proposed model list including the proposed device models, and to receive user selection of a proposed model from the displayed list of proposed device models; adding a specified device of the selected model to a proposed fleet of devices; and generating a proposed state analysis of the proposed fleet of devices.

In another example, the method may include permitting the user to select any of (ii) a current models only mode in which the selection user interface permits the user to add to the proposed fleet of devices only a device of a model selected from a current model list of device models amongst a current fleet of devices employed by the customer, (ii) a proposed models only mode in which the selection user interface permits the user to add only a device of a model selected from the proposed model list, and (iii) a proposed models and current models mode in which the selection user interface permits the user to add a device of a model selected from the current model list or the proposed model list; displaying in the selection user interface, in the current models only mode, only the current model list and not displaying the proposed model list; displaying in the selection user interface, in the proposed models only mode, only the proposed model list and not displaying the current model list; and displaying in the selection user interface, in the proposed models and current models mode, both of the current model list and the proposed model list.

In another example, the method may include permitting the user to select any of (ii) a current models only mode in which the selection user interface permits the user to add to the proposed fleet of devices only a device of a model selected from a current model list of device models amongst a current fleet of devices employed by the customer, (ii) a proposed models only mode in which the selection user interface permits the user to add only a device of a model selected from the proposed model list, and (iii) a proposed models and current models mode in which the selection user interface permits the user to add a device of a model selected from the current model list or the proposed model list. In the current models only mode, the proposed state analysis is generated based on only devices of models in the current model list, and in the proposed models only mode, the proposed state analysis is generated based on only devices of models in the proposed model list.

Further, the method may optionally also include any of various other steps, such as: automatically populating the proposed model list with available models identified in a contract database; providing the same proposed model list for generating multiple proposed state analyses and multiple proposed fleets of devices, for the customer; providing the same proposed model list for generating proposed state analyses and proposed fleets of devices, for multiple customers; providing the same proposed model list for generating multiple proposed state analyses based on respective proposed fleets of devices, for multiple sites of the customer.

### BRIEF DESCRIPTION OF THE DRAWINGS

The aforementioned and other aspects, features and advantages can be more readily understood from the following detailed description with reference to the accompanying drawings wherein:

FIG. 1 shows a block diagram of a system within which a device marketing application operates to generate a proposed state analysis of a proposed fleet of devices for a customer, according to an exemplary embodiment;

FIG. 2 shows a block diagram of a system within which a device marketing application operates to generate a proposed state analysis of a proposed fleet of devices for a customer, according to another exemplary embodiment;

FIG. 3 shows a block diagram of an exemplary configuration of a computing device that can be configured by software to operate as a server;

FIG. 4 shows a block diagram of an exemplary configuration of a terminal or a terminal apparatus;

FIG. 5 shows a block diagram of an exemplary configuration of a multi-function device;

FIG. 6 shows a schematic representation of current state and proposed state for a site;

FIG. 7 shows a flow chart of a method, according to an exemplary embodiment, which can be performed in any of the systems shown in FIGS. 1 and 2;

FIGS. 8A-8G show respective examples of user interface screens provided on a terminal apparatus, according to an exemplary embodiment;

FIG. 9 shows a flow chart of a method, according to an exemplary embodiment, which can be performed in any of the systems shown in FIGS. 1 and 2;

FIGS. 10A-10K show respective examples of user interface screens provided by a terminal apparatus, according to an exemplary embodiment;

FIG. 11 shows a flow chart of a method, according to an exemplary embodiment, which can be performed in any of the systems shown in FIGS. 1 and 2;

FIGS. 12A-12J show respective examples of user interface screens provided by a terminal apparatus, according to an exemplary embodiment.

### DETAILED DESCRIPTION

In describing exemplary embodiments illustrated in the drawings, specific terminology is employed herein for the sake of clarity. However, this disclosure is not intended to be limited to the specific terminology so selected and it is to be understood that each specific element includes all technical equivalents that operate in a similar manner. In addition, a detailed description of known functions and configurations is omitted from this specification when it may obscure the inventive aspects described herein.

Various tools to facilitate a proposed state analysis are discussed herein, with reference to a device marketing application. It should be appreciated by those skilled in the art that any one or more of such tools may be embedded in another application and/or in any of various other ways, and thus while various examples are discussed herein, the inventive aspects of this disclosure are not limited to such examples described herein.

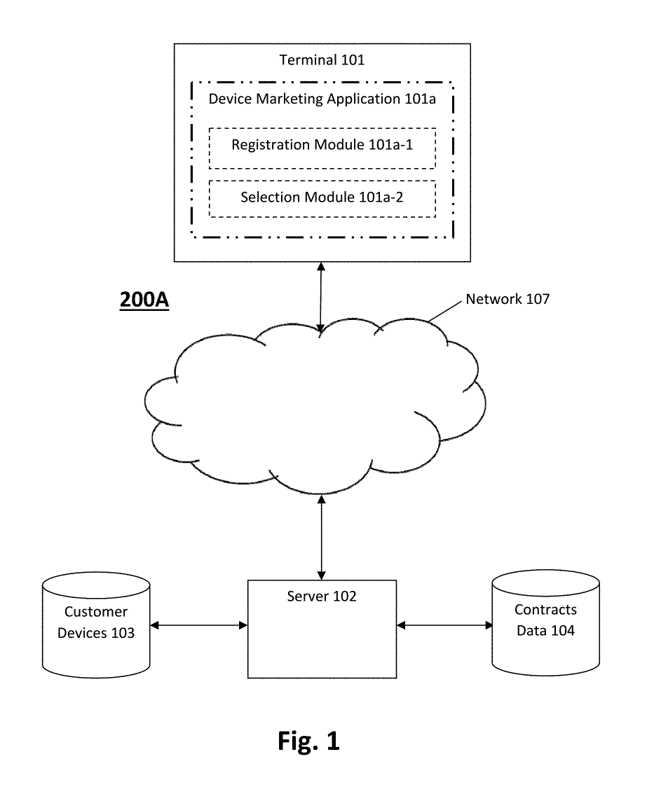

FIG. 1 shows schematically a system 200A that includes a terminal 101 and a server 102, which are interconnected by network 106. Although only one terminal is shown in FIG. 1, it should be understood that a plurality of user terminal devices (which can have similar or different configurations) can be provided in the system.

The terminal 101 can be any computing device, including but not limited to a personal, notebook or workstation computer, a kiosk, a PDA (personal digital assistant), a mobile phone or handset, another information terminal, etc., that can communicate with other devices through the network 107. The terminal 101 is further described infra with reference to FIG. 4.

In the system shown in FIG. 1, a device marketing application 101a is hosted on or provided to a terminal 101, to perform analysis and calculations with regards to a set (or fleet) of one or more specified devices, and includes a registration module 101a-1 and selection module 101a-2.

The device marketing application 101a may be a native program installed on the terminal 101, or may be provided from an external source as an application and/or as part of a platform, or may be provided as a service (e.g., software as a service, i.e. SaaS).

The registration module 101a-1 provides a user interface to a user of the terminal 101 to display one or more device models from which the user can select to generate a proposed model list. Such device models may be various types of devices (e.g., printers, MFPs, facsimile machines, scanners, etc.) manufactured by different companies (e.g., ABC Co., DEF Inc., LMN Corp., XYZ Manu. Co., etc.). For example, the registration module 101a-1 may display a list of products (i.e. device models) sold by ABC, from which the user can select one or more of a particular ABC product. After the user has selected at least one device model, he or she may add the selected device model to the proposed model list.

The proposed model list is generated by the registration module 101a-1 and can be filled in by the user with one or more device models displayed by the registration module 101a-1. Further, the proposed model list can be designated to a particular customer or a category (e.g., university, corporation, government, etc.) that encompasses two or more customers. For example, it may be that a certain set of device models may be more suitable (i.e. practical) to one company or entity (e.g., university) than another set of device models. In another example, certain devices may be not be permitted to be sold to customers located in a specific country (e.g., Republic of Korea) because the certain devices may infringe upon existing products in that specific country. Thus, the proposed model list is convenient method by which to organize one or more device models for one or more customers.

The selection module 101a-2 provides a user interface through which the user can generate a proposed state analysis for one or more customers. Such proposed state analysis includes one or more device models that may be proposed as a fleet of devices for a customer. In other words, for example, the proposed state analysis may contain a group of devices originating from various (or only one) manufacturers that may best fulfill the needs of an entire office of a company. In one exemplary embodiment, the user may be the one who determines which set of device models may be best suited for the customer. In another exemplary embodiment, the device marketing application 101a-1 determines the set of devices that may be the most efficient, practical or cost effective for the customer.

In addition, the selection module 101a-2 may also display one or more proposed model list corresponding to the customer for which the proposed state analysis is being generated. The user may select device models (included in the proposed model list) to be included in the proposed state analysis. In one exemplary embodiment, the user may select one or more proposed model list to be displayed by the selection module 101a-2. In another example, as soon as the user generates a proposed state analysis for a particular customer, the proposed model list corresponding to the particular customer is automatically displayed to the user. Further, in another exemplary embodiment, the user cannot select any device models other than the proposed model list displayed automatically by the selection module 101-2. In either case, the user is not forced to determine which device models are appropriate and, instead, may easily obtained the device models that are suitable for the proposed state analysis.

The server 102 may be used to access information regarding customer device models and contracts data which are stored in the customer devices database 103 and contracts data database 104, respectively.

For example, the customer devices database 103 may include information regarding a fleet of devices (e.g., printer, MFP, scanner, facsimile machine, etc.) for each customer. In other words, each customer may have an office, at a certain geographical location (e.g., city, town, etc.), that may include a fleet of devices. Information regarding each of the devices in the fleet of devices, such as name or identifier (e.g., device name, walkthrough ID, Asset tag, etc.), device type (e.g., printer, MFP, scanner, etc.), device functions (e.g., black & white, duplex, fax, scanning, N-up, etc.), physical location, network address (e.g., IP address, MAC address, etc.), output technology (e.g., laser, inkjet solid ink, thermal, other technology, etc.), supply level (e.g., level of consumable, such as paper and toner, is empty, low, ok, etc.), pages per job (e.g., 1, 2, 6-10, etc.), color technology (e.g., professional color, convenience color, etc.), device properties (e.g., manufacturer, model, serial number, etc.), etc. are stored in the customer devices database 103.

In another example, the customer device information in the customer devices database 103 may in the form of a spreadsheet (e.g., Excel). In other words, the user may request from the customer information on the fleet of devices currently possessed by the customer by having the customer fill out an electronic spreadsheet with data (e.g., identifier, device type, functions, color technology, etc.) corresponding to each device. Such spreadsheet may be sent to the user electronically (e.g., e-mail), after which, the spreadsheet is stored in the customer devices database 103.

The contracts database 104 includes information regarding contracts made by an organization employing the user with one or more customers. In other words, the organization may have made a specific contract with a particular customer in which the specific contracts include one or more device models that can be sold to the particular customer. For example, the particular customer may be located in a country that permits the organization to sell only four or five of their device models. This may be because all the other products by the organization may infringe on products made by other companies doing business in the country. Thus, the specific contract may only include those four or five device models. In another example, the specific contract may include device models that have been sold at a reduced price. This may be because, all device models sold by the company may be too expensive for certain entities such as a university. However, in a special deal with the university, the organization may sell only some (e.g., six or seven) devices models at a reduced price (e.g., 50% of original price). Thus, the contract indicates which of the device models manufactured by the organization are sold at a reduced price.

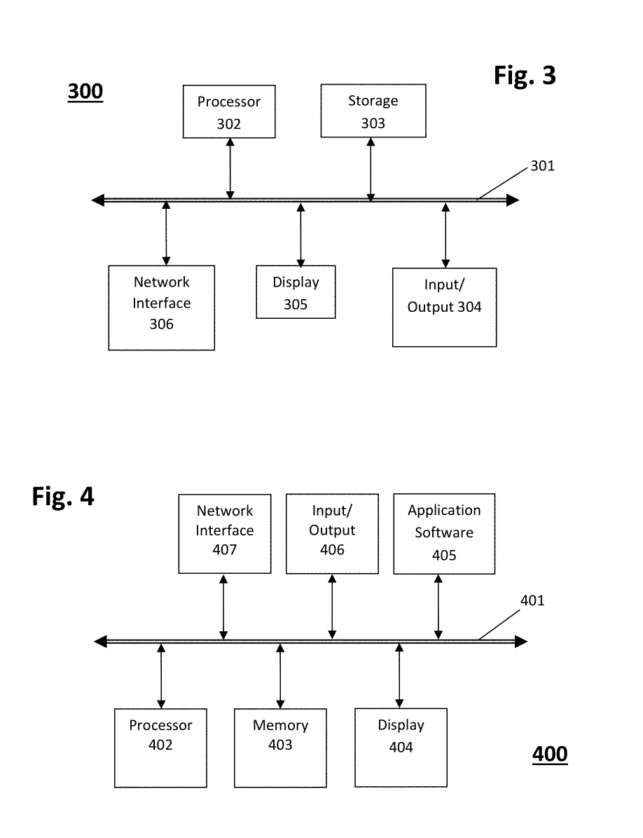

Therefore the user may access the server 102 to obtain information regarding customer devices and contracts without having to manually input the information, thereby making it more convenient for the use. The server 102 is further described infra with reference to FIG. 3.

The network 107 can be a local area network, a wide area network or any type of network such as an intranet, an extranet (for example, to provide controlled access to external users, for example through the Internet), a private or public cloud network, the Internet, etc., or a combination thereof. Further, other communications links (such as a virtual private network, a wireless link, etc.) may be used as well for the network 106. In addition, the network 106 preferably uses TCP/IP (Transmission Control Protocol/Internet Protocol), but other protocols such as SNMP (Simple Network Management Protocol) and HTTP (Hypertext Transfer Protocol) can also be used. How devices can connect to and communicate over networks is well-known in the art and is discussed for example, in “How Networks Work”, by Frank J. Derfler, Jr. and Les Freed (Que Corporation 2000) and “How Computers Work”, by Ron White, (Que Corporation 1999), the entire contents of each of which are incorporated herein by reference.

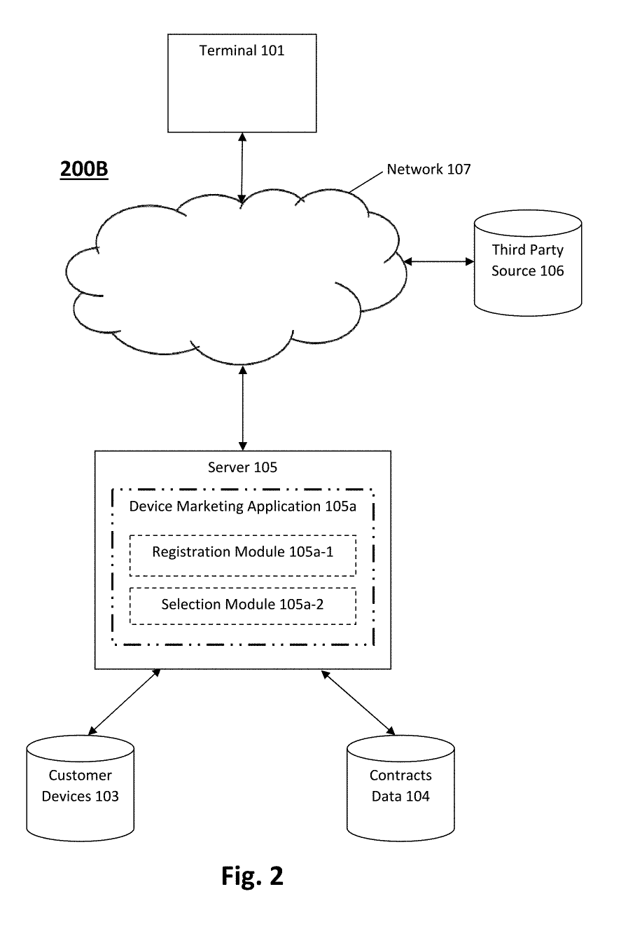

FIG. 2 shows schematically a system 200B, according to another exemplary embodiment. The system 200B is similar to the system 200A of FIG. 1 except that the system additionally includes a third party source 106.

The server 105 may include a device marketing application 105a which in turn comprises a registration module 105a-1 and a selection module 105a-2. It should be noted that the device marketing application 102a, the registration module 105a-1 and the selection module 105a-2 are similar to the device marketing application 101a, the registration module 101a-1 and the selection module 101a-2, respectively.

In this case, the device marketing application 105a is not pre-installed on the terminal 101 and is instead downloaded, or provided as a service, to the terminal 101 from the server 105. Thus, in the case in which the user wishes to access the device marketing application 105a, the terminal 101 may send a request to the server 105. In response to such request, the server 105 may provide the device marketing application 105a to the terminal 101. However, before sending the software the server 105 may check user credentials. If the user has authorization to access the features of the device marketing application 105a the server 105 provides the device marketing application 105a to the terminal 101. Otherwise, the device marketing application 105a is not provided to the terminal 101. The server 105 is further described infra with reference to FIG. 3.

The third party source database 106 may be a database belonging to any number of third party entities. Further, there may more than one third party source database connected to the network 107. For example, the third party source database may belong to an organization such as a device manufacturer, a retail establishment or an online retailer. Each of the aforementioned organizations may publicly store device models that they are selling. Thus, in the case that the user of the terminal 101 attempts to obtain the devices currently being possessed by a customer by accessing a spreadsheet sent by the customer, the user may discover that the spreadsheet is missing certain information (e.g., price, functions, monthly volume, energy usage, etc.). This may be because the customer simply does not have knowledge of every device in their possession. Consequently, the device marketing application 102a may automatically communicate with the third party source database 106 to obtain the missing device information and complete the spreadsheet.

Otherwise, operations of the elements of the system 200B are similar to those discussed in connection with the corresponding elements of the system 200A of FIG. 1.

FIG. 3 shows an exemplary constitution of a computing device that can be configured (for example, through software) to operate (at least in part) as the sever 102. In FIG. 3, apparatus 300 includes a processor (or central processing unit) 302 that communicates with a number of other components, including memory or other storage device(s) 303, input/output (e.g., keyboard, mouse, etc.) 304, display 305 and network interface 306, by way of a system bus 301. The apparatus 300 may be a special-purpose device (such as including one or more application specific integrated circuits or an appropriate network of conventional component circuits) or it may be software-configured on a conventional personal computer or computer workstation with sufficient memory, processing and communication capabilities to operate as a terminal and/or server, as should be appreciated by those skilled in the relevant art. In the management apparatus 300, the processor 302 executes program code instructions that control device operations. The processor 302, memory/storage 303, input/output 304, display 305 and network interface 306 are conventional, and therefore in order to avoid obfuscating the inventive aspects of this disclosure, such conventional aspects are not discussed in detail herein. Such aspects and components are discussed, for example, in “How Computers Work”, by Ron White (Que Corporation 1999), and “How Networks Work”, by Frank J. Derfler, Jr. and Les Freed (Que Corporation 2000), the entire contents of each of which are incorporated herein by reference.

The apparatus 300 includes the network interface 306 for communications through a network, such as communications through the network 107. However, it should be appreciated that the subject matter of this disclosure is not limited to such configuration. For example, the apparatus 300 may communicate with user terminals through direct connections and/or through a network to which some components are not connected. As another example, the apparatus 300 does not need to be provided by a server that services terminals, but rather may communicate with the devices on a peer basis, or in another fashion.

The apparatus 300 of the present disclosure is not limited to a server or computer, but can be manifested in any of various devices that can be configured to communicate over a network and/or the Internet.

An exemplary constitution of the terminal 101 of FIGS. 1 and 2 is shown schematically in FIG. 4. In FIG. 4, terminal 400 includes a processor (or central processing unit) 402 that communicates with various other components, such as memory (and/or other storage) 403, display 404, application software 405, input/output (such as keyboard, mouse, touchpad, stylus, microphone and/or speaker with voice/speech interface and/or recognition software, etc.) 406 and network interface 407, by way of an internal bus 401.

The processor 402, memory/storage 403, display 404, input/output 406, and network interface 407 are conventional, and therefore in order to avoid obfuscating the inventive aspects of this disclosure, such conventional aspects are not discussed in detail herein.

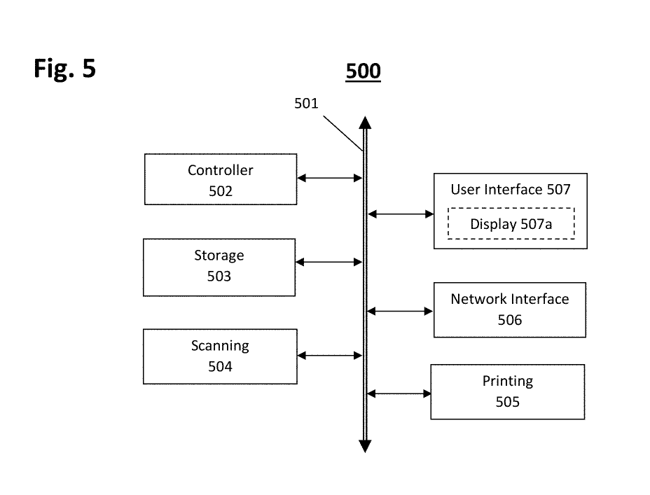

FIG. 5 shows a schematic diagram of a configuration of an output device as an MFP (multi-function printer or multi-function peripheral) device. The output device 500 shown in FIG. 5 includes a controller 502, and various elements connected to the controller 502 by an internal bus 501. The controller 502 controls and monitors operations of the output device 500. The elements connected to the controller 502 include storage 503 (for example, random access memory, read-only memory, hard disk drive, portable storage media drive such as for optical discs, magnetic discs, magneto optical discs, etc., semiconductor memory cards, combinations of storage media, etc.), scanning 504, printing 505, a network interface (I/F) 506, a user interface 507.

Storage 503 can include one or more storage parts or devices [e.g., a read only memory (for example, ROM, PROM, EPROM, EEPROM, etc.), a random access memory (RAM), a hard disk drive (HDD), portable media (for example, floppy disk, optical disc, magnetic discs, magneto-optical discs, semiconductor memory cards, etc.) drives], and program code instructions can be stored in one or more parts or devices of storage 403 and executed by the controller 502 to carry out the instructions. Such instructions can include instructions for performing specified functions (such as printing, scanning, faxing, copying, e-mailing, etc.) of the output device 500, to enable the output device 500 to interact with a terminal, as well as perhaps other external devices, through the network interface 407, and interactions with users through the user interface 507.

The network interface 506 is utilized by the output device 500 to communicate via a network with other network-connected devices such as a terminal, a server and receive data requests, print (or other) jobs, user interfaces, and etc.

The user interface 507 includes one or more electronic visual displays that display, under control of controller 502, information allowing the user of the output device 500 to interact with the output device 500. The electronic visual display can be any of various conventional displays (such as a liquid crystal display, a plasma display device, a cathode ray tube display, etc.), but preferably is equipped with a touch sensitive display (for example, liquid crystal display) and may be configured to provide a GUI (graphical user interface) based on information input by an operator of the output device 500, so as to allow the operator to interact conveniently with services provided on the output device 500, or with the output device 500 serving as terminal for accessing electronic data or other content through the network. User interfaces or other contents received through the network via the network interface 506 can be displayed on the display screen.

Scanning 504, printing 505, and network interface 506 are otherwise conventional, and therefore, a detailed description of such conventional aspects is omitted in the interest of clarity and brevity. The output device 500 can have any or all of the functions of similar devices conventionally known, such as for scanning, editing and storing images, sending a fax, sending and receiving e-mails with or without attachments, accessing files by FTP or another protocol or facility, surfing the Web, scan-to-folder, scan-to-email, etc. Further, multi-functional devices or multi-function peripheral devices can play a prominent role to convert hardcopy documents to electronic documents.

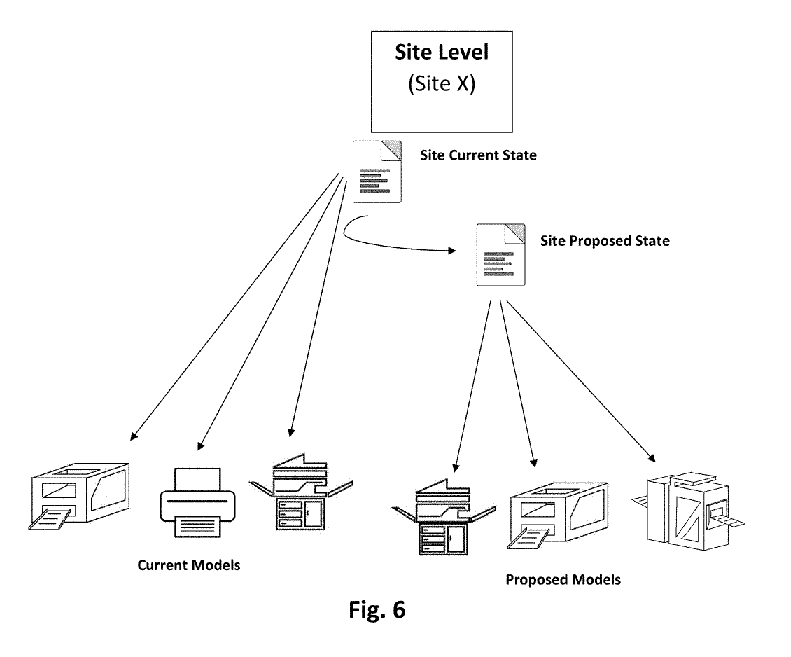

FIG. 6 shows schematically that a site (“Site A”) may have one set of device models for the current state and another set of device models for generating a proposed state. Thus, it is not necessary that one device model at Site A is to be replaced at a time. Instead, a salesman may look at the entire fleet of devices at Site A and replace all of them with newer device models.

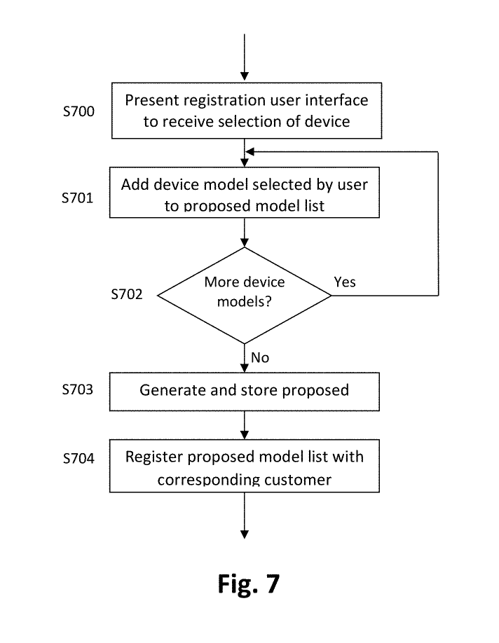

FIG. 7 show a method that can be performed by a device marketing application (e.g., 101a) on a terminal apparatus (e.g., 101), according to an exemplary embodiment.

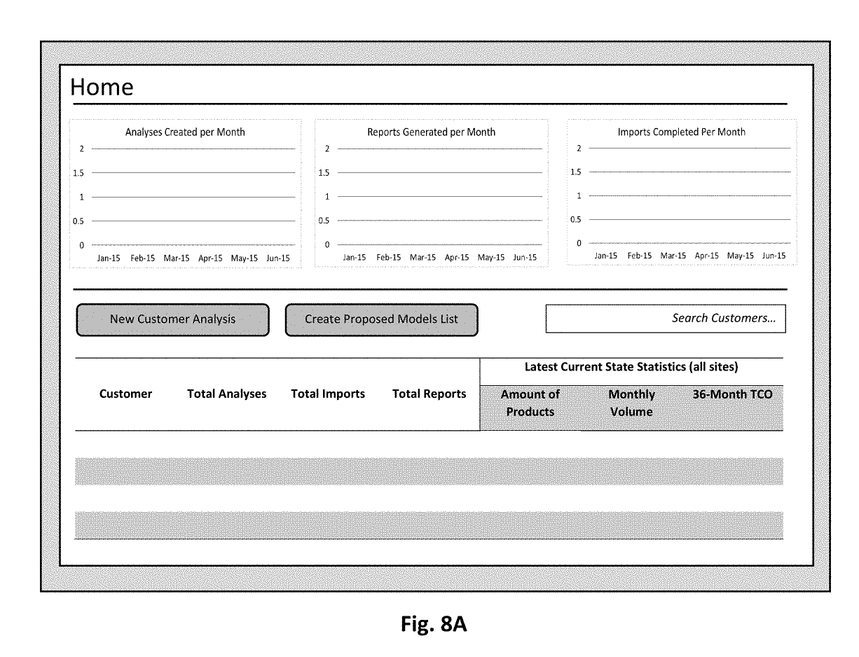

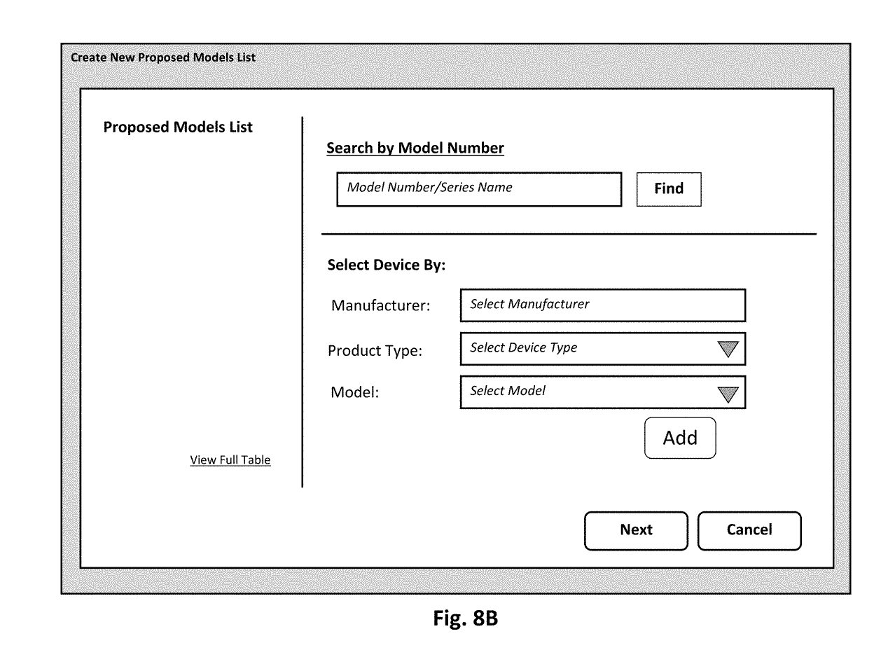

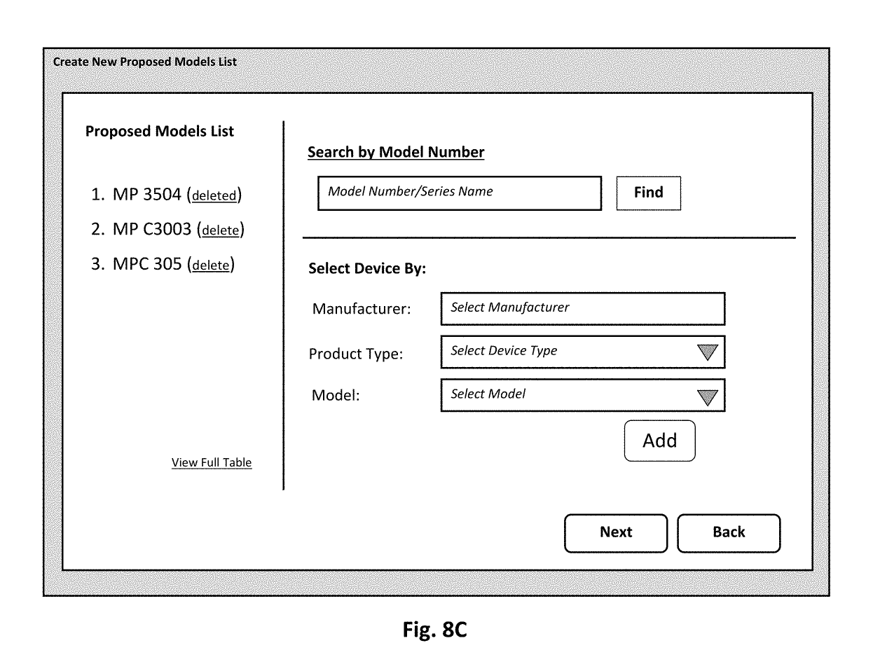

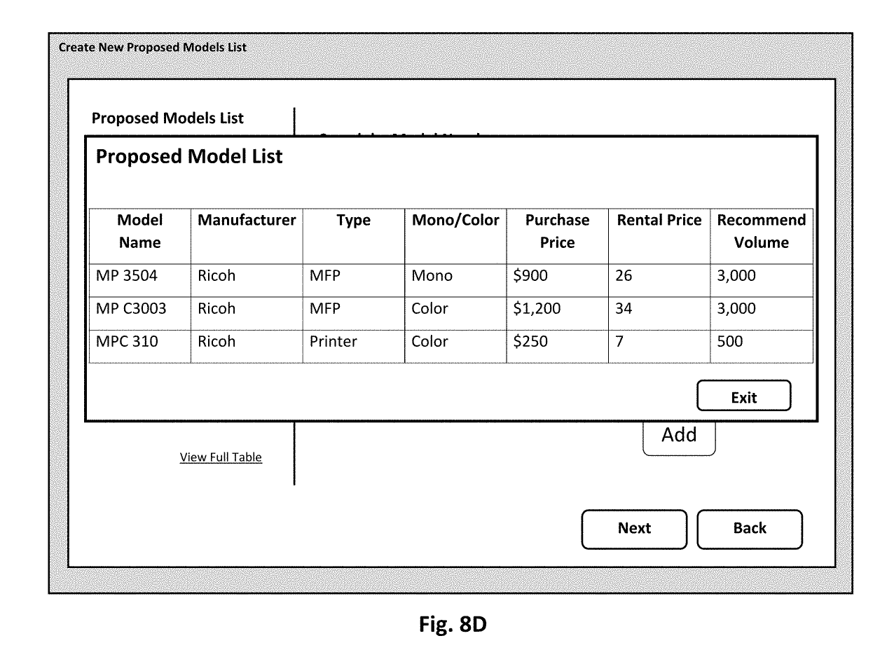

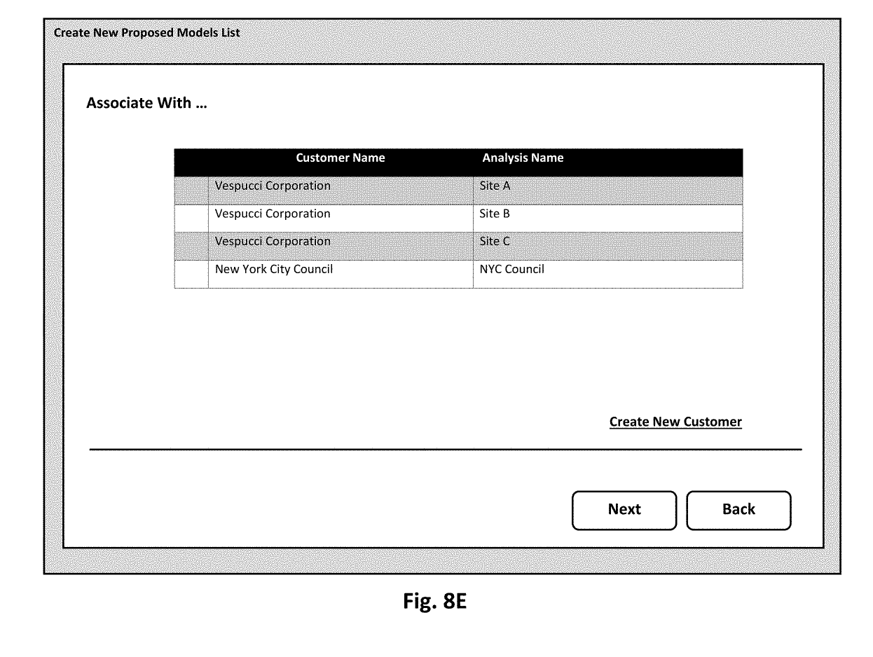

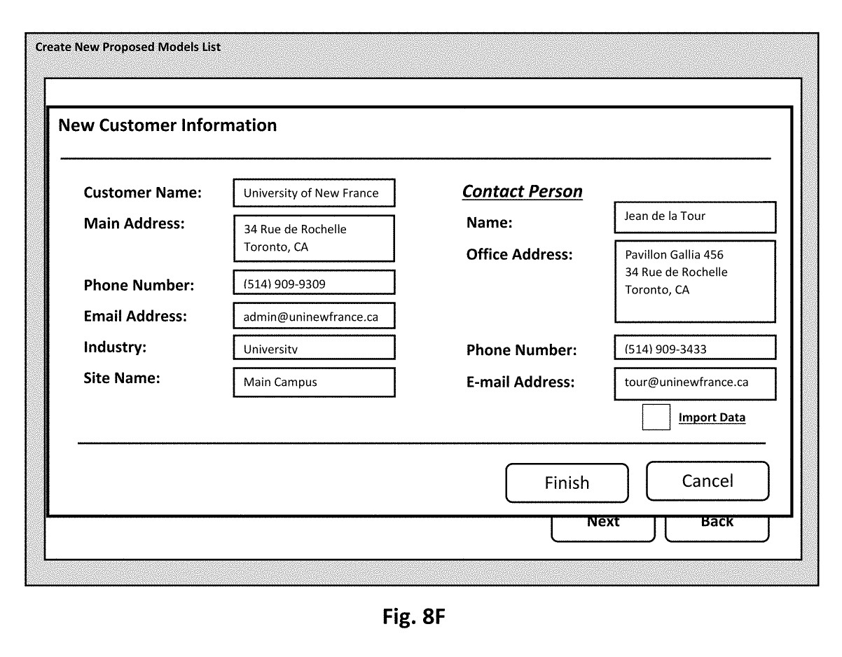

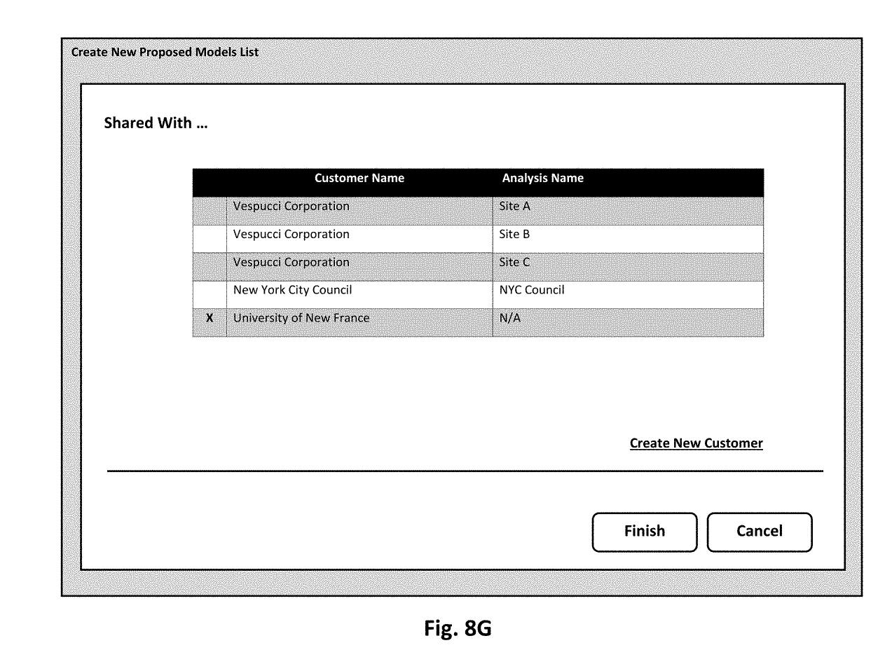

In the example shown in FIGS. 8A-8G, the user is a salesman employed by vendor “Ricoh Corporation” and his responsibilities include advising potential (or existing) customers what device models manufactured by Ricoh Corporation would be suitable for them. In one scenario, a head (“Jean de la Tour”) of the Nanotechnology department at the “University of New France” determines from complaints by the professors in the department regarding the out-dated nature of their devices (e.g., printers, MFPs, scanners, facsimiles, etc.) that his department is in need of newer devices. Thus, Professor de la Tour telephones the user to provide his department with a proposed list of device models produced by Ricoh Corporation that can replace the out-dated devices in his department. In response, the user sends a spreadsheet to Professor de la Tour and asks him to fill out the spreadsheet with data on the current devices that Professor de la Tour has in his department.

While the user is waiting for Professor de la Tour to complete the spreadsheet, the user decides to generate a proposed model list on his terminal. In this scenario, Ricoh Corporation usually sells high-end devices to large corporations which can afford them. However, the user is aware that the University of New France is not a large corporation and has a relatively smaller budget. Thus, the user, who is an experienced salesperson, realizes that only a small portion of devices manufactured by Ricoh Corporation are suitable (e.g., in terms of pricing, function, size, etc.) for the Nanotechnology department of the University of New France.

To begin, the user accesses a device marketing application (e.g., 101a) which causes a home screen to be displayed to the user, such as shown in FIG. 8A. Since the user would like to first generate a proposed model list, he activates the “Create Proposed model list” button which causes the device marketing application to present a user interface to receive selections of device models by the user (step S700), such as shown in FIG. 8B. The user may search for device models by model number or may instead find a particular device model by criteria. After he finds the particular device model that he wants, he activates the “add button” which causes the device marketing application to add the selected device model to the proposed model list (step S701).

In one exemplary embodiment, the device models that the user can select from include only devices manufactured by Ricoh Corporation. In another exemplary embodiment, the user can select devices manufactured by other companies. For example, Ricoh Corporation may have a subsidiary, “Lanier Limited”, which was previously an independent company. Since Lanier's brand is still strong, Ricoh Corporation may still be disposed to sell Lanier products. In another example, Ricoh Corporation may have made a deal with another company, “Sombreros Printing S.A.”, to sell their devices in Canada (the location of the University of New France).

After the user has added at least one device model, the added device model is shown in the proposed model list which is represented as a list to the left of the screen, such as shown in FIG. 8C. The user can delete device models off the proposed model list by activating the “delete” button corresponding to the device model that he wishes to delete. The user can further view information (e.g., specifications) regarding each of the device models that he has added to the proposed model list by activating the “View Full Table” button. This causes a table including more information (e.g., model, manufacturer, color/mono, purchase price, rental price, recommended volume, etc.) regarding each of the device models in the proposed model list to be displayed to the user, such as shown in FIG. 8D.

After the user has added at least one device model to the proposed model list, the device marketing application determines whether another device model is to be added (step S702). In the case that the user wishes to add more device models (step S702, yes), the process repeats. Otherwise, in the case that the user is finished with generating the proposed model list by (step S702, no), the device marketing application generates and stores the proposed model list (step S703). Next, the device marketing application requests the user to register the proposed model list with a corresponding customer by presenting the user with a table of existing customers (step S704), such as shown in FIG. 8E.

However, since the University of New France is a new customer, it has not yet been entered into the customer table. Thus, the user may add a new customer by activating the “Create New Customer” button which causes a screen for entering new customer information to be presented to the user, such as shown in FIG. 8F. After entering the relevant customer information, the user activates the “Finished” button which causes the University of New France to be added to the customer table, such as shown in FIG. 8G. Next, the user checkmarks the box associated with the University of New France and activates the “Finish” button to complete the process of generating a proposed model list.

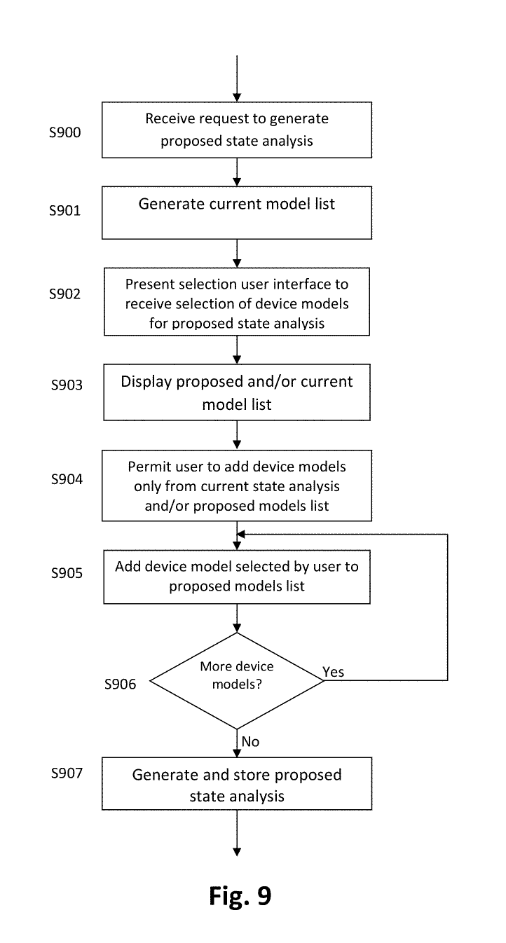

FIG. 9 show a method performed by a device marketing application (e.g., 101a) on a terminal apparatus (e.g., 101), according to an exemplary embodiment.

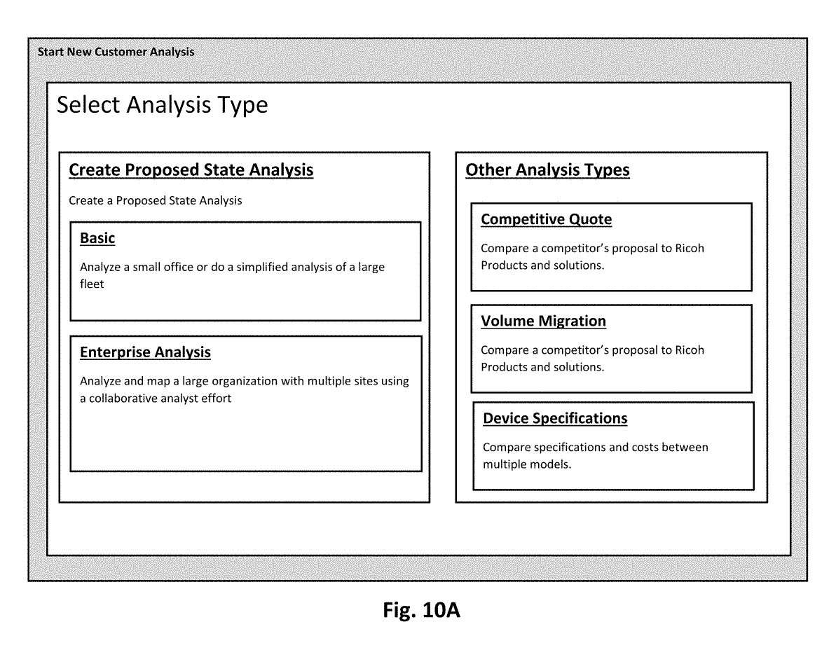

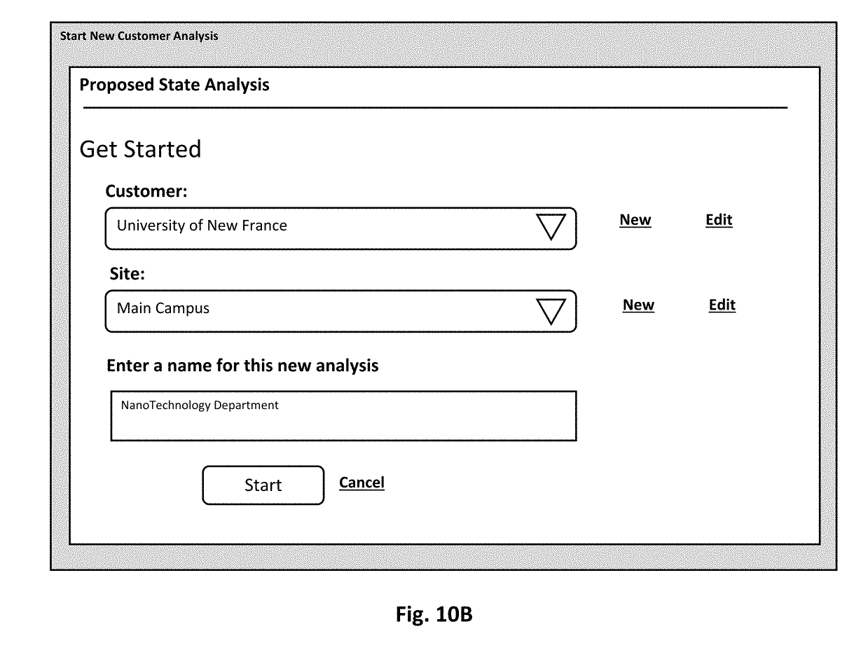

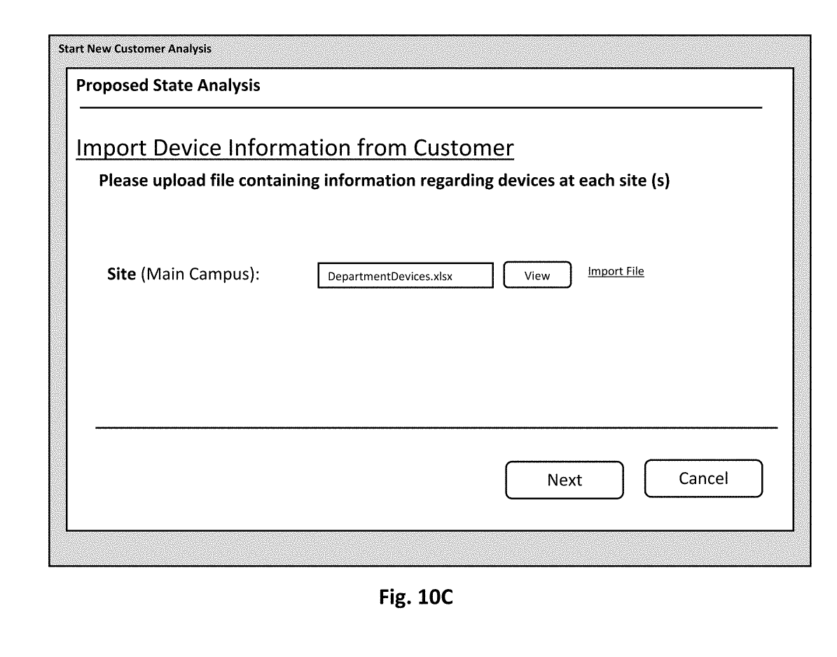

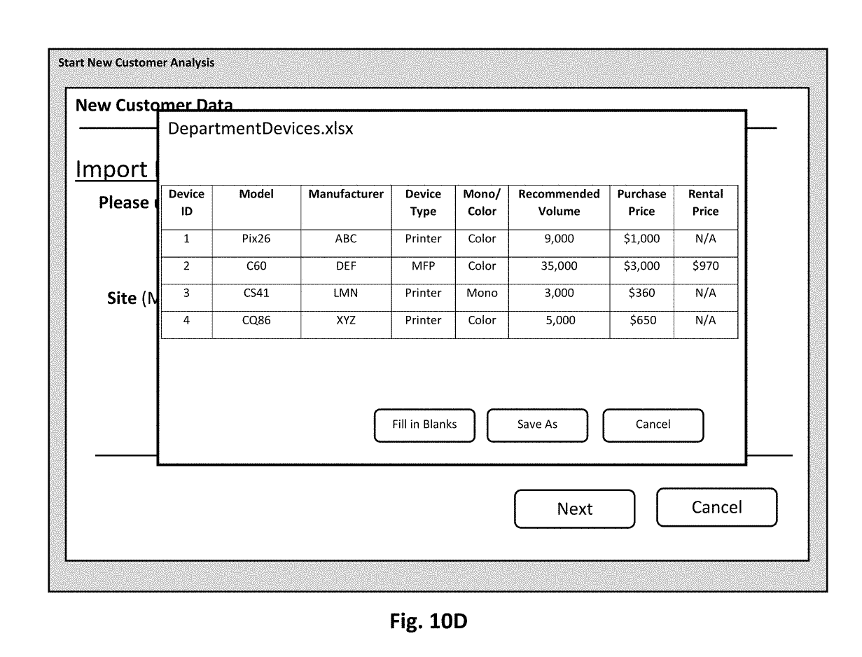

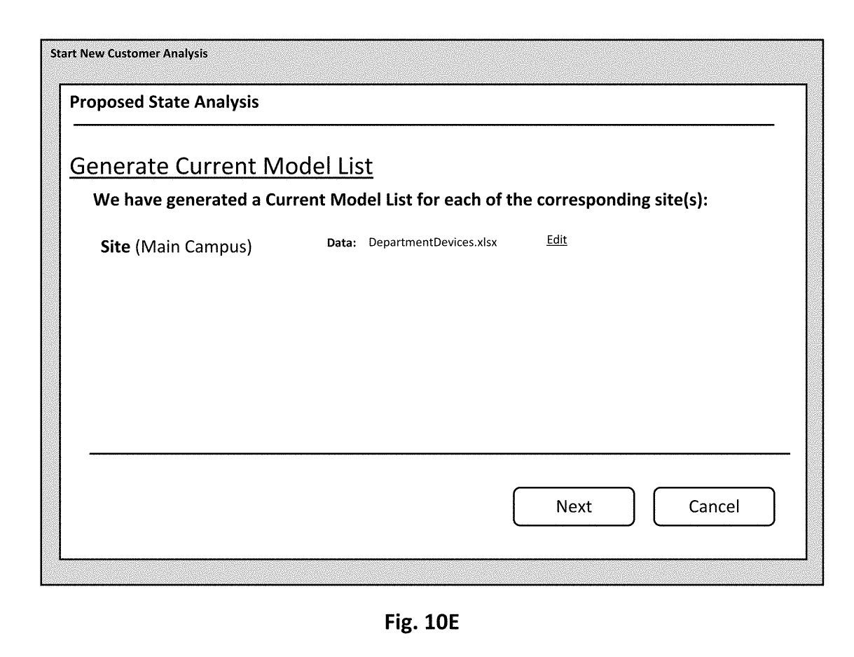

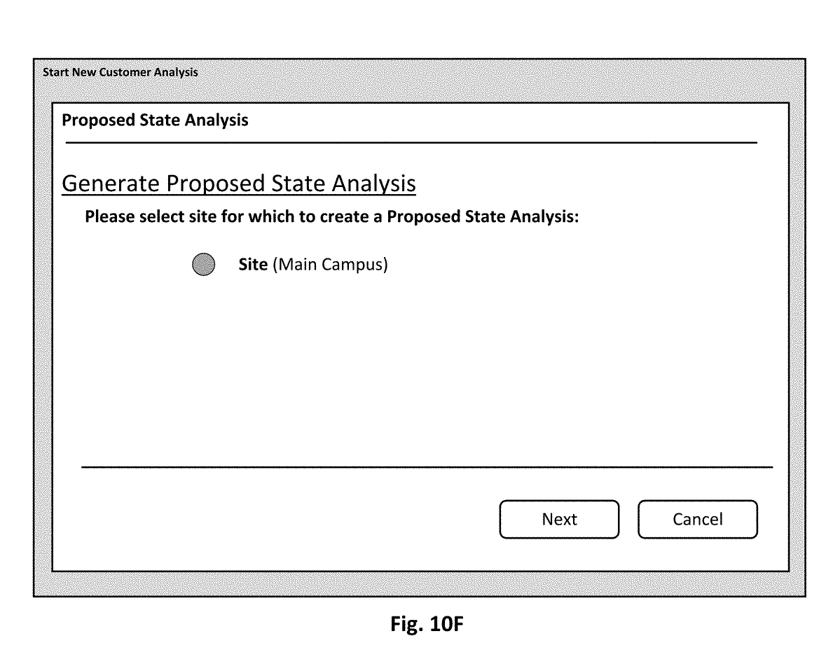

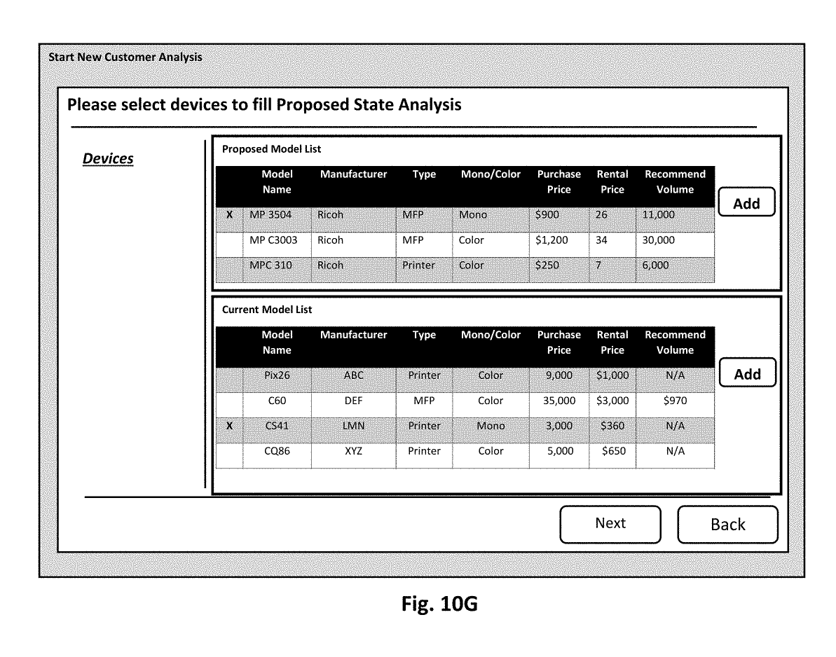

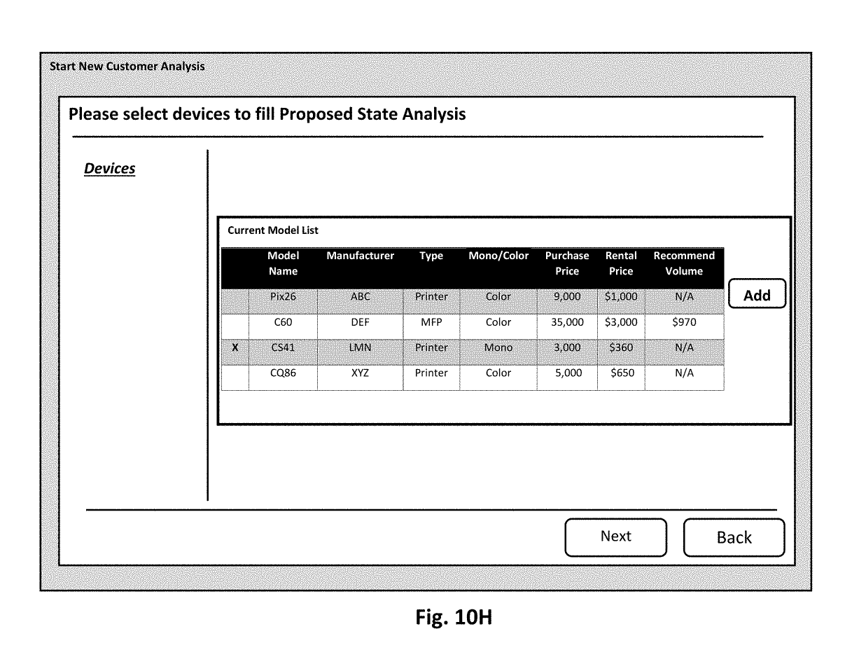

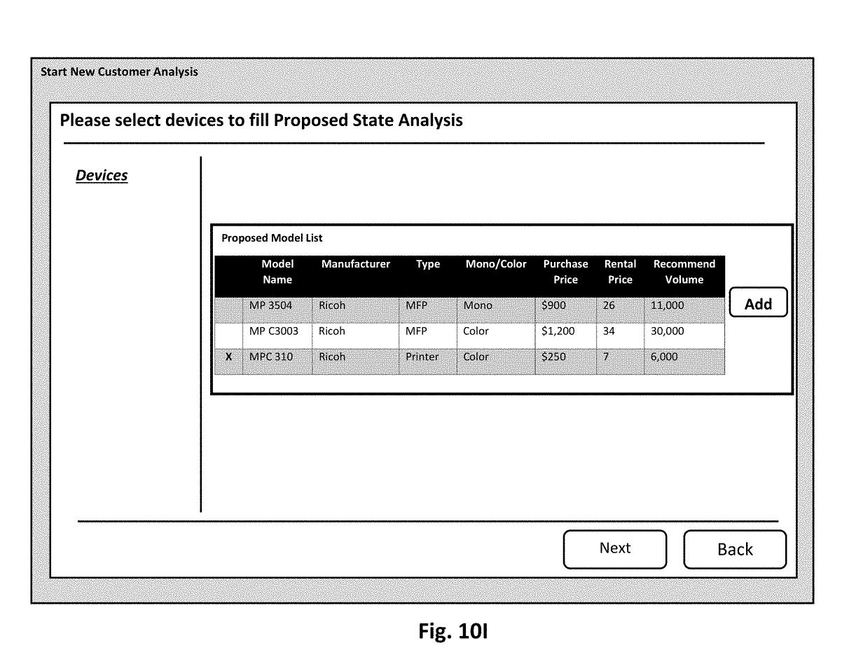

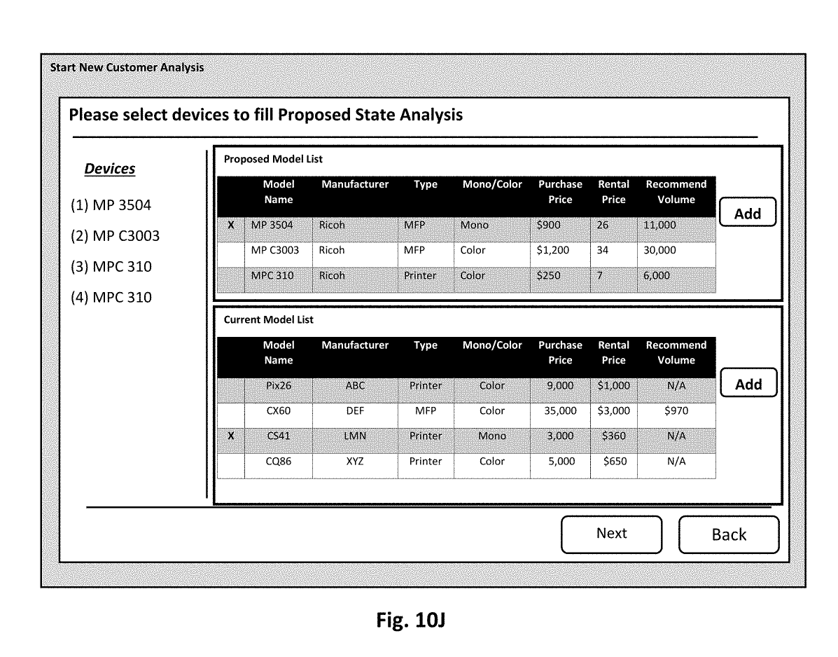

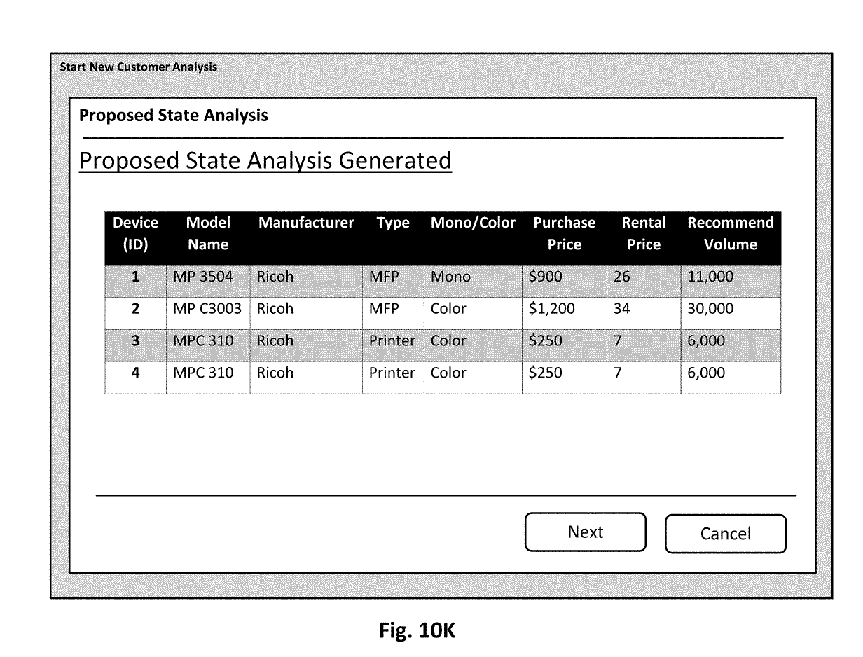

A short while after the user has generated the proposed model list, he may receive an e-mail from Professor de la Tour which contains the completed spreadsheet that includes all of the information regarding the devices in the Nanotechnology department of the University of New France. Consequently, the user can now start generating the proposed state analysis for Professor de la Tour. The user commences this action by activating the “New Customer Analysis” button (step S900), such as shown previously in FIG. 8A. Next, since the user is doing a proposed analysis for a university which is small (e.g., only one location with limited budget), he activates the “Basic” button, such as shown in FIG. 10A.

Then the user selects (i) the customer (i.e. University of New France) for which he is generating the proposed state analysis, (ii) the corresponding site and (iii) an identifier for the proposed state analysis, such as shown in FIG. 10B. Afterwards, the device marketing application requests that the user upload a file including all the current device models corresponding to the customer (e.g., spreadsheet received from Professor de la Tour) in order to generate a current model list, such as shown in FIG. 10C. The user can view the spreadsheet received from Professor de la Tour again by activating the “View” button, such as shown in FIG. 10D. Next, after the user confirms that the spreadsheet is correct, the device marketing application generates and stores the current models list (step S901), such as shown in FIG. 10E.

Next, the device marketing application prompts the user to select a site corresponding to the customer for which the proposed state analysis is to be generated, such as shown in FIG. 10F. In this case, since the University of New France is only at one location, there is only one site (i.e. “Main Campus”) to which the user can select. Then, the device marketing application presents a user interface form which the user can select device models to be added to the proposed state analysis (step S902), such as shown in FIG. 10G. In addition, the device marketing application may also provide (or automatically display) the user with the current model list and the proposed model list (step S903), such as shown in FIG. 10H. It should be noted that, in one example, the user is not forced to select a proposed model list. The device marketing application may automatically display the most recently generated proposed model list corresponding to the customer.

In an exemplary embodiment, the device marketing application does not have to present both the current model list and the proposed model list to the user. In other words, the user may be operating in one of three modes (i.e. current models only mode, proposed models only mode, or proposed models and current models mode). In the case that the user is operating in a “current models only mode”, the device marketing application may display only the current model list, such as shown in FIG. 10H. Likewise, in the case that the user is operating in a “proposed models only mode” the device marketing application may display only the proposed model list, such as shown in FIG. 10I. Further, in the case that the user is operating in a “proposed models and current models mode”, the device marketing application may display both the current model list and the proposed model list to the user.

In another exemplary embodiment, the user has no control over which mode that he or she is operating in. For example, the mode that the user is set in may be determined by the user's account and rank. In other words, a senior salesman may have access to the “proposed models and current models mode” while an entry level salesman may have only access to the “current models only mode”.

In this case, the user has access to the “proposed models and current models mode”. Thus, he can generate a proposed state analysis by selecting device models from the current model list or the proposed model list via the “add” button (step S904). After receiving the selected device model from the user (step S905), the device marketing application determines if there are any more device models to be added to the proposed state analysis (step S906). In the case that there are more device models to be added (step S906, yes), the process repeats. Otherwise, in the case that there are not more device models to be added (step S906, no), such as shown in FIG. 10J, the device marketing application generates and stores the proposed state analysis (step S907). Further, the device marketing application displays the newly generated proposed state analysis to the user, such as shown in FIG. 10K.

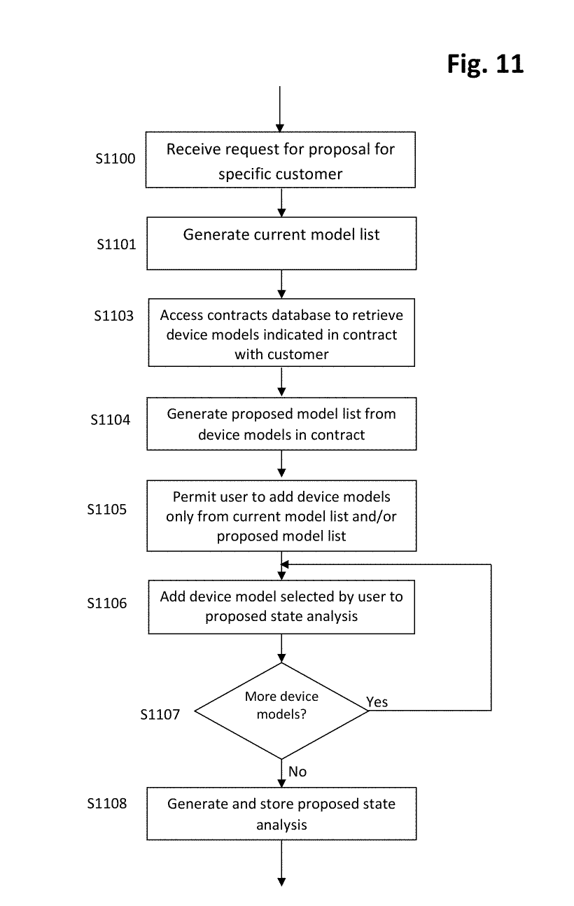

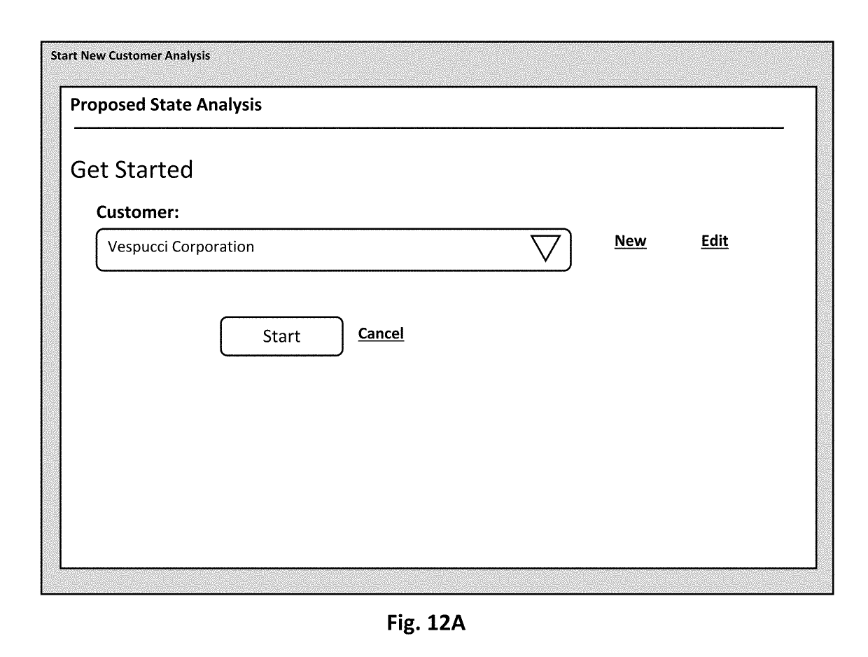

FIG. 11 show a method performed by a device marketing application (e.g., 101a) on a terminal apparatus (e.g., 101), according to an exemplary embodiment.

After the user has generated the proposed state analysis for Professor de la Tour, he may receive a communication from “Mark” who is employed by the “Vespucci Corporation”. Mark explains to the user that employees of the Vespucci are unsatisfied with performance of devices currently employed by the Vespucci. On the other hand, Mark also tells the user that the employees are very satisfied with devices manufactured by Ricoh Corporation. According to Mark, Vespucci would like to replace all other devices with Ricoh devices (step S1100).

Like previously, the user informs Mark that he needs a list of current devices and corresponding information to generate a proposal. Accordingly, the user sends a file to Mark and asks him to fill it out. After receiving the filled out form from Mark, the user imports the data in the file into the application, and the user commences the process to generate a proposal by activating the “New Customer Analysis” button. The application provide a user interface screen, and in response, the user activates the “Enterprise Analysis” button, such as shown in FIG. 10A, since the customer (i.e. Vespucci) is a multi-national company with offices (e.g., Montreal Office, Los Angeles Office and Mexico City Office) in different countries.

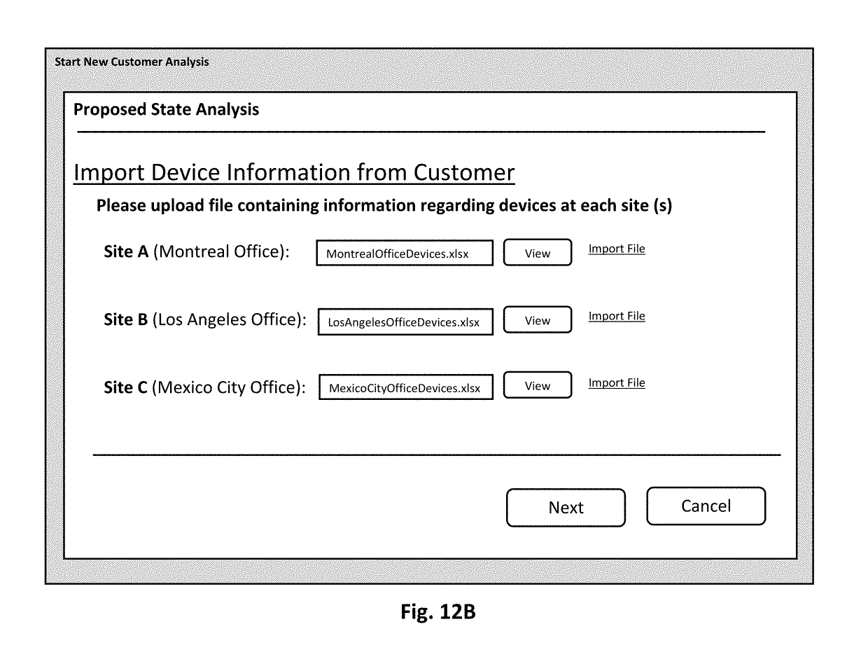

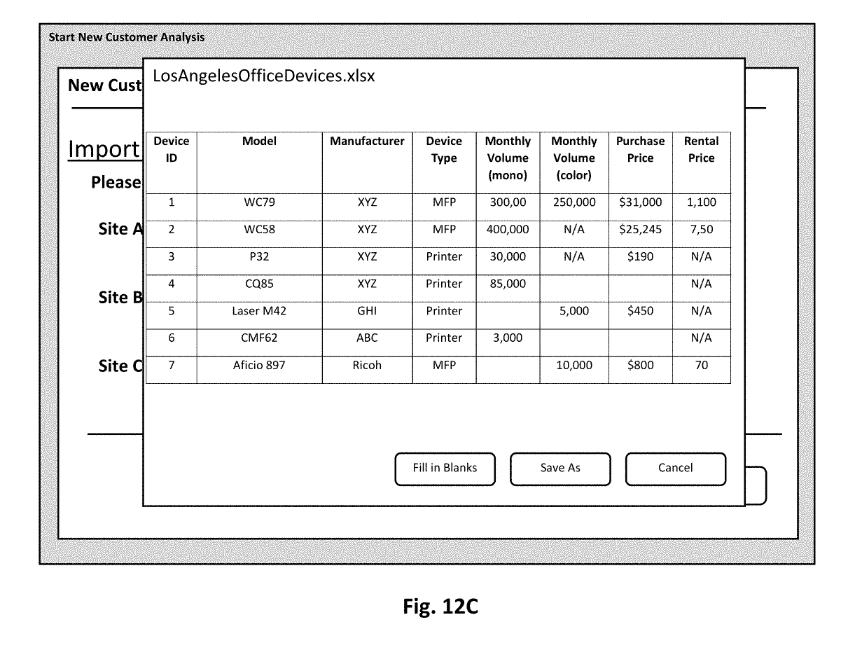

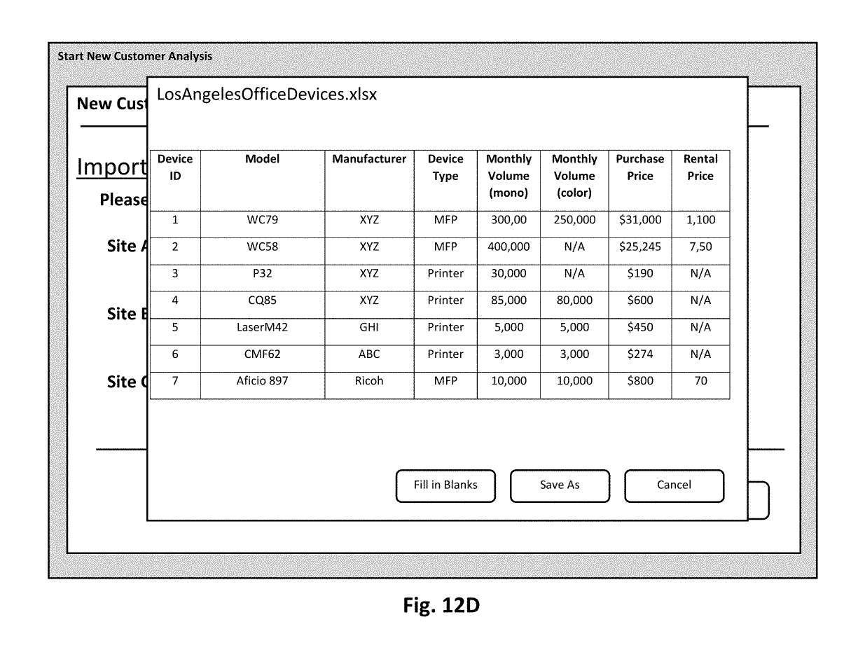

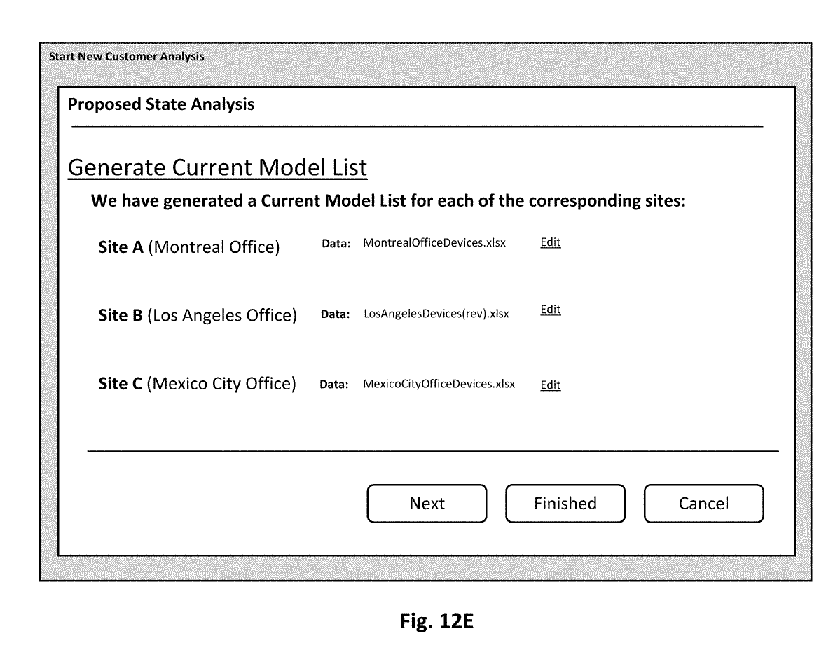

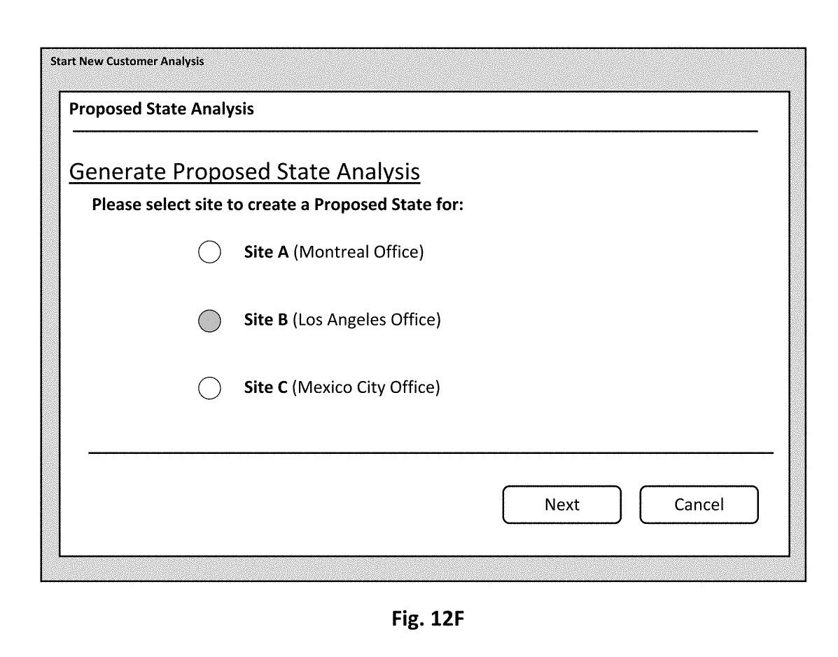

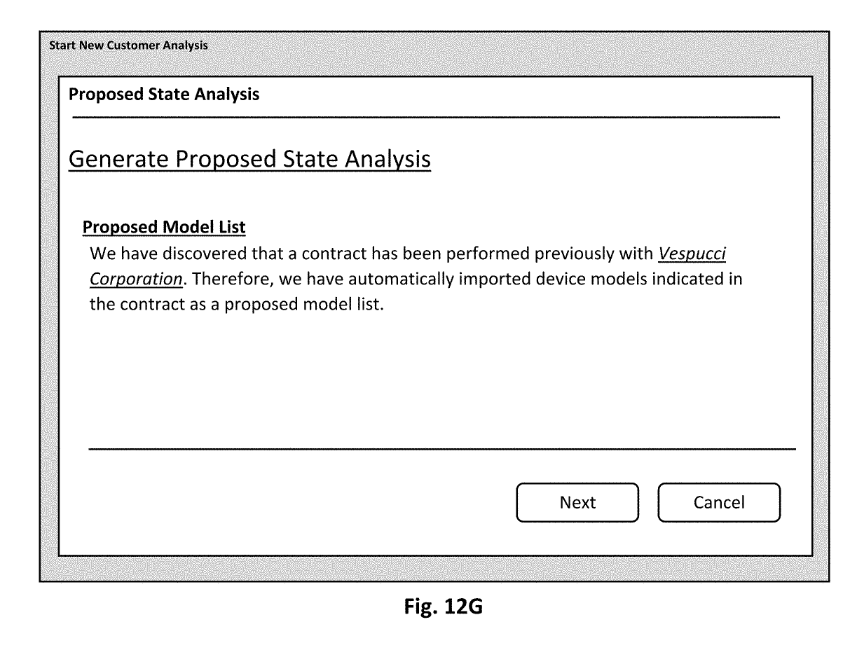

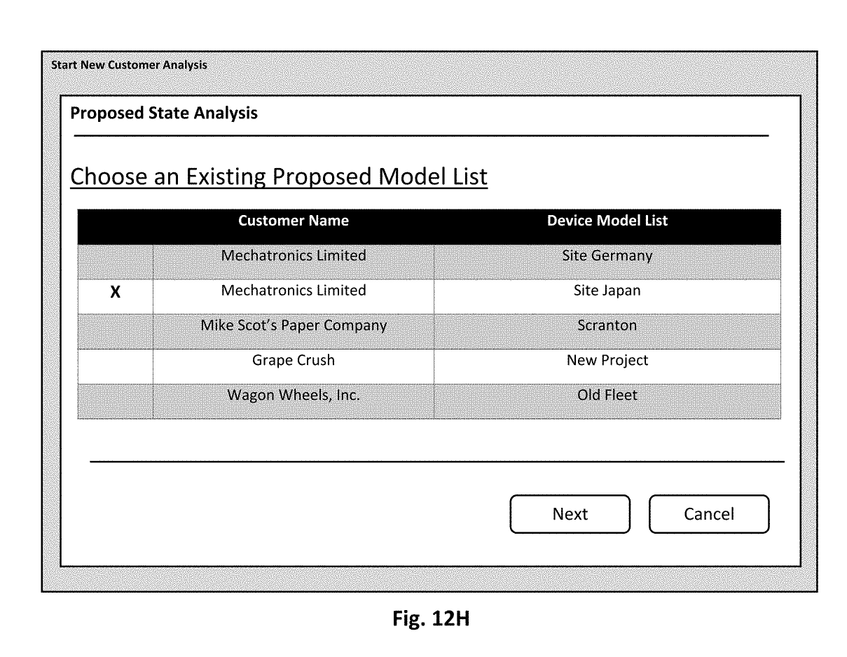

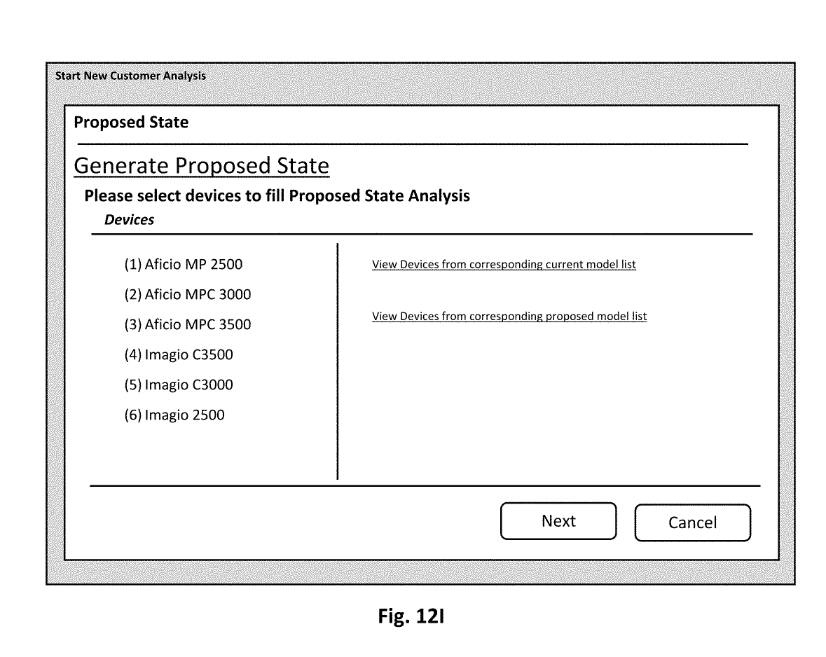

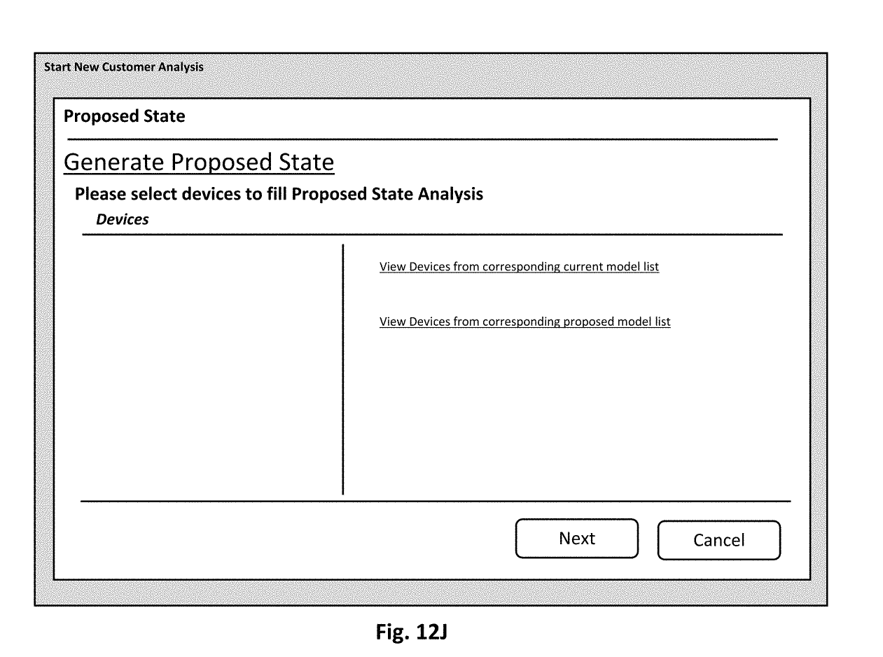

The application prompts the user to specify a customer for which a proposed state analysis is to be generated, such as shown in FIG. 12A. Since Vespucci is an existing customer, the user can select Vespucci as the customer without having to generate a new profile. Next, the application requests that the user import information regarding the devices at each of the offices (i.e. Site A, Site B and Site C) of the customer, such as shown in FIG. 12B. The user may view the file provided by the customer, such as shown in FIG. 12C.

In an exemplary embodiment, the file including the information of each device at a certain customer office (e.g., Los Angeles Office) may not be complete. It may be that records were destroyed or lost, so that the file is only partially filled out, as evident from the blank spaces in the spreadsheet portrayed in FIG. 12C. The value “N/A” reflects the customer's indication that the particular information may not exist. For example, the device of device model “WorkCentre 5890” has an “N/A” under the category “Monthly Volume (color)” because such device does not have any color function and not because Mark doesn't know what value to put in that category. Thus, when there is incomplete information in the table of devices, the user can complete the table by activating the “Fill in Blanks” button which causes the device marketing application to communicate with a third party source (e.g., Amazon, Best Buy, Newegg, Staples, PC Richard and Son, etc.) to obtain information that can complete the table. Once the table is completed, such as shown in FIG. 12D, the user can save the completed table by activating the “Save As” button which causes the file to be saved as “LosAngelesDevices(rev).xlsx”.

After the user is satisfied with the completed table, the application generates a current model list (step S1101) and the user is informed of such current model list, such as shown in FIG. 12E.

Next, the device management application prompts the user to select a site for which to perform a proposed state analysis, and in this instance, the user selects the “Los Angeles Office”, such as shown in FIG. 12F. Next, since there has been a contract previously performed between Ricoh Corporation and Vespucci, the device marketing application automatically obtains the contract by searching a contracts database and importing device models that are indicated in the contract (step S1103). In an exemplary embodiment, not all of the devices manufactured by Ricoh Corporation are in the contract. In another example, the contract may indicate that various models are to be sold at a discounted price.

Next, after obtaining all of the device models in the contract, the device marketing application automatically generates a proposed model list based on the device models indicated in the contract (step S1104), such as shown in FIG. 12G. In an exemplary embodiment, the user can select a proposed model list previously generated for different customers, such as shown in FIG. 12H. It may be that one of the companies for which a proposed model list has been previously generated is very similar to Vespucci in terms of size, needs and industry. Thus, the user may simply select the previously generated proposed model list as a proposed model list for the proposed state analysis.

After the proposed model list has been generated for this proposed state analysis, the user can still add device models to the proposed state analysis. For example, the user can add device models from the current model list by activating the “View Devices from current model list” button, or add devices models from the proposed model list by activating the “View Devices from corresponding proposed model list” button (step S1105), such as shown in FIG. 12I. After receiving the selected device model from the user (step S1106), the device marketing application determines if there are any more device models to be added to the proposed state analysis (step S1107). In the case that there are more device models to be added (step S1107, yes), the process repeats. Otherwise, in the case that there are not more device models to be added (step S1107, no), such as shown in FIG. 12J, the device marketing application generates and stores the proposed state analysis (step S1108).

The orders in which the steps are performed in the aforementioned methods are not limited to those shown in the examples of FIGS. 7, 9 and 11, and may be switched as long as similar results are achieved. Also, it should be noted that the methods illustrated in the examples of FIGS. 7, 9 and 11 may be implemented using any of the systems described in connection with FIGS. 1 and 2.

The aforementioned specific embodiments are illustrative, and many variations can be introduced on these embodiments without departing from the spirit of the disclosure or from the scope of the appended claims. In addition, elements and/or features of different examples and illustrative embodiments may be combined with each other and/or substituted for each other within the scope of this disclosure and appended claims.

What is claimed is:

1. A device marketing application configured to generate a proposed state analysis of a proposed fleet of devices for a customer, the device marketing application including one or more programs of instructions embodied in a non-transitory computer readable medium and executable by a computer to configure the computer to comprise:
a registration module that includes a registration user interface to receive user selection of a device model from a system database, the registration module registering the selected device model amongst proposed device models maintained by the registration module; and
a selection module that includes a selection user interface to display a proposed model list including the proposed device models registered by the registration module, and receive user selection of a proposed model from the displayed list of proposed device models and add a specified device of the selected model to the proposed fleet of devices for the proposed state analysis.

2. The device marketing application as claimed in claim 1, wherein the selection user interface provided by the selection module additionally displays a current model list of device models amongst a current fleet of devices employed by the customer, and the selection user interface permits the user to select a current model from the current model list and add the selected current model to the proposed fleet of devices for the proposed state analysis.

3. The device marketing application as claimed in claim 2, wherein the selection user interface is configured to operate in any of (ii) a current models only mode in which the selection user interface permits the user to add only a device of a model selected from the current model list to the proposed fleet of devices, (ii) a proposed models only mode in which the selection user interface permits the user to add only a device of a model selected from the proposed model list, and (iii) a proposed models and current models mode in which the selection user interface permits the user to add a device of a model selected from the current model list or the proposed model list.

4. The device marketing application as claimed in claim 3, wherein
in the current models only mode, the selection user interface displays only the current model list and does not display the proposed model list,
in the proposed models only mode, the selection user interface displays only the proposed model list and does not display the current model list, and
in the proposed models and current models mode, the selection user interface displays both of the current model list and the proposed model list.

5. The device marketing application as claimed in claim 3, wherein
in the current models only mode, the proposed state analysis is generated based on only devices of models in the current model list, and
in the proposed models only mode, the proposed state analysis is generated based on only devices of models in the proposed model list.

6. The device marketing application as claimed in claim 1, wherein the selection module automatically populates the proposed model list with available models identified in a contract database.

7. The device marketing application as claimed in claim 1, wherein the registration module automatically registers amongst proposed device models maintained by the registration module device models amongst a current fleet of devices employed by the customer, and
the registration module permits the user to unregister a current model from the proposed device models maintained by the registration module.

8. The device marketing application as claimed in claim 1, wherein the proposed model list is available for generating multiple proposed state analyses and multiple proposed fleets of devices, for the customer.

9. The device marketing application as claimed in claim 1, wherein the same proposed model list is available for generating proposed state analyses and proposed fleets of devices, for multiple customers.

10. The device marketing application as claimed in claim 1, wherein the same proposed model list is available for generating multiple proposed state analyses based on respective proposed fleets of devices, for multiple sites of the customer.

11. The device marketing application as claimed in claim 1, wherein the proposed model list is available to each user amongst multiple users.

12. The device marketing application as claimed in claim 1, wherein the proposed model list displayed in the selection user interface includes device information including device manufacturer, device type, recommended volume, and at least one of purchase price and rental price.

13. A method performed by a device marketing application including one or more programs of instructions embodied in a non-transitory computer readable medium and executed by a computer, the method comprising:
providing a registration user interface to receive user selection of a device model from a system database;
registering the selected device model amongst proposed device models;
providing a selection user interface to display a proposed model list including the proposed device models, and to receive user selection of a proposed model from the displayed list of proposed device models;
adding a specified device of the selected model to a proposed fleet of devices; and
generating a proposed state analysis of the proposed fleet of devices.

14. The method as claimed in claim 13, further comprising:
permitting the user to select any of (ii) a current models only mode in which the selection user interface permits the user to add to the proposed fleet of devices only a device of a model selected from a current model list of device models amongst a current fleet of devices employed by the customer, (ii) a proposed models only mode in which the selection user interface permits the user to add only a device of a model selected from the proposed model list, and (iii) a proposed models and current models mode in which the selection user interface permits the user to add a device of a model selected from the current model list or the proposed model list;
displaying in the selection user interface, in the current models only mode, only the current model list and not displaying the proposed model list;
displaying in the selection user interface, in the proposed models only mode, only the proposed model list and not displaying the current model list; and
displaying in the selection user interface, in the proposed models and current models mode, both of the current model list and the proposed model list.

15. The method as claimed in claim 13, further comprising:
permitting the user to select any of (ii) a current models only mode in which the selection user interface permits the user to add to the proposed fleet of devices only a device of a model selected from a current model list of device models amongst a current fleet of devices employed by the customer, (ii) a proposed models only mode in which the selection user interface permits the user to add only a device of a model selected from the proposed model list, and (iii) a proposed models and current models mode in which the selection user interface permits the user to add a device of a model selected from the current model list or the proposed model list,
wherein in the current models only mode, the proposed state analysis is generated based on only devices of models in the current model list, and in the proposed models only mode, the proposed state analysis is generated based on only devices of models in the proposed model list.

16. The method as claimed in claim 13, further comprising:
automatically populating the proposed model list with available models identified in a contract database.

17. The method as claimed in claim 13, further comprising:
providing the same proposed model list for generating multiple proposed state analyses and multiple proposed fleets of devices, for the customer.

18. The method as claimed in claim 13, further comprising:
providing the same proposed model list for generating proposed state analyses and proposed fleets of devices, for multiple customers.

19. The method as claimed in claim 13, further comprising:
providing the same proposed model list for generating multiple proposed state analyses based on respective proposed fleets of devices, for multiple sites of the customer.
